(19) United States
(12) Patent Application Publication
(10) Pub. No.: US 2004/0034861 A1
(43) Pub. Date: Feb. 19, 2004

(54) System and method for automating firmware maintenance

(76) Inventor: Philip N. Ballai, San Jose, CA (US)

Correspondence Address: OLEG F. KAPLUN, ESQ., FAY, KAPLUN & MARCIN, LLP, 150 BROADWAY, SUITE 702, NEW YORK, NY, 10038, US

(21) Appl. No.: 10/224,099

(22) Filed: Aug. 19, 2002

(51) Int. Cl. G06F 13/10; G06F 9/00; G06F 9/44

(52) U.S. Cl. 719/321; 719/327; 717/168

(57) ABSTRACT

Described is a system and method for automatically updating a firmware program. During an initialization process of a portable card (e.g., a wireless radio card), a first version of the firmware program is determined. The first version is a version which is currently stored in a non-volatile memory of the card that is connected with a computing device. The first version is compared with a second version of the firmware program. The first version is automatically updated with the second version in the non-volatile memory if the second version is a subsequent verison of the firmware program. After the firmware is updated, the card is activated using the second version.

### BACKGROUND INFORMATION

Wireless local area networks (“WLANs”) provide a fast and easy way to connect devices to a communication network. Many enterprises are now beginning to implement WLANs on a wide scale by installing radio cards that can communicate over the WLAN. Many manufacturers are even beginning to integrate these radio cards into devices. There is, therefore, a need to develop technologies to more efficiently manage the radio cards.

One common set of protocols used to implement the WLAN is an IEEE 802.11 protocol. A radio card that implements the IEEE 802.11 protocol typically uses firmware, a program that runs on the radio card and controls the radio card's basic functions. The firmware is stored in a nonvolatile memory bank of the radio card (i.e., memory that saves data when the power is off).

The firmware is periodically updated to fix bugs and add new software features. As a result, most vendors provide a software utility application to allow a user to update the firmware version on the radio card. In order to make the maintenance of the radio card more reliable and seamless, there is a need for an automated maintenance system that would automatically update the firmware without the need for the user's intervention.

### SUMMARY OF THE INVENTION

Described is a system and method for automating the maintenance of the firmware. During an initialization process of a portable card (e.g., a wireless radio card), a first version of the firmware program is determined. The first version is a version which is currently stored in a non-volatile memory of the card that is connected with a computing device. The first version is compared with a second version of the firmware program. The first version is automatically updated with the second version in the non-volatile memory if the second version is a subsequent verison of the firmware program. After the firmware is updated, the card is activated using the second version.

### BRIEF DESCRIPTION OF DRAWINGS

FIG. 1 shows an exemplary embodiment of a computing device utilizing a radio card according to the present invention;

FIG. 2 shows an exemplary embodiment of a communications network including the computing device illustrated in FIG. 1 according to the present invention; and

FIG. 3 shows an exemplary embodiment of a method according to the present invention.

### DETAILED DESCRIPTION

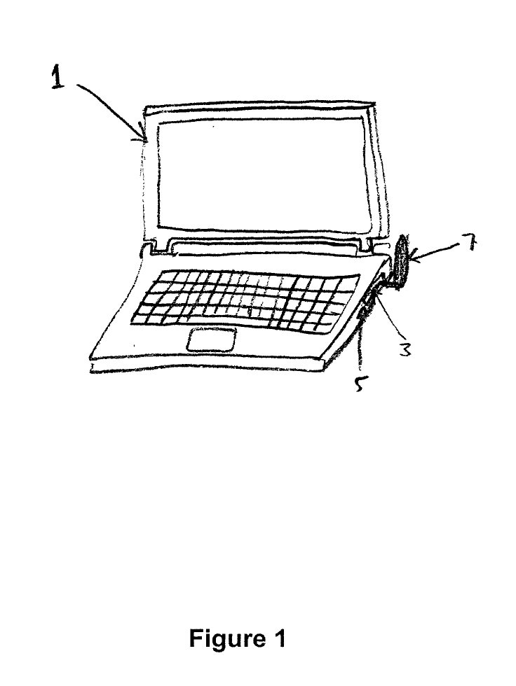

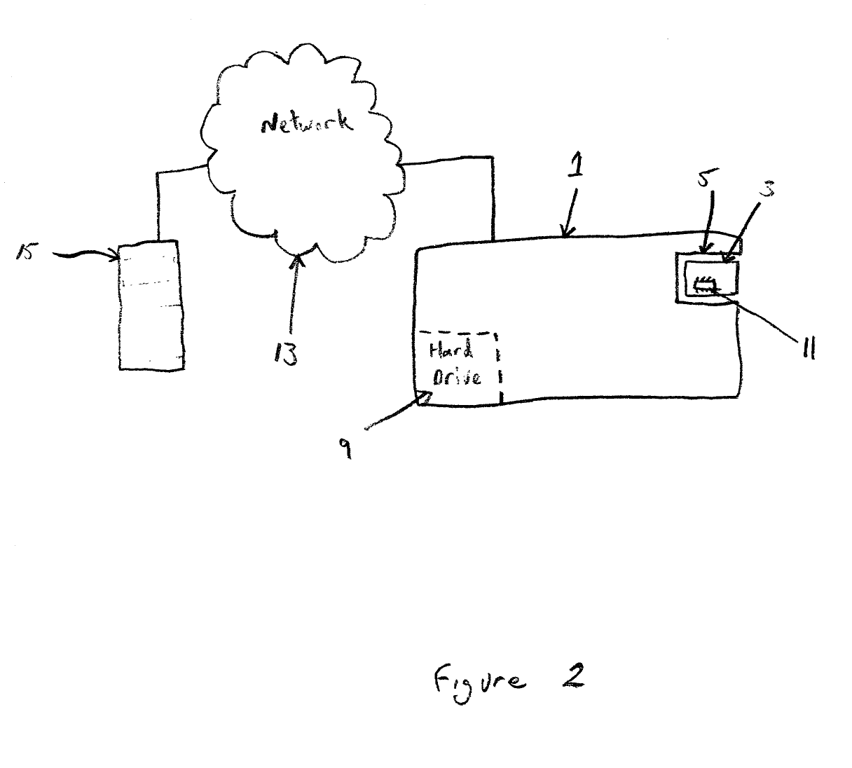

FIGS. 1 and 2 show an exemplary embodiment according to the present invention of a computing device 1. The communication network 13 may include a wireless local area network (“WLAN”) which may operate using the 802.11 protocol. The computing device 1 may be a desktop or laptop personal computer, a personal digital assistant, a printer, a cellular telephone, etc. The computing device 1 may be equipped with a portable card 3 which may be installed/inserted into a slot 5 (e.g., a Personal Computer Memory Card International Association standard slot) or pre-installed by a manufacturer of the computing device 1. The portable card 3 may have a radio card which may include an attached antenna 7 in order to facilitate radio transmission. Those skilled in the art would understand that other types of portable cards 3 may also be utilized.

The card 3 may contain a nonvolatile memory 11 which is capable of retaining information when the power is turned off. The nonvolatile memory 11 may contain firmware (i.e., a software program that controls the card 3 hardware) allowing upper layer drivers to interact with the card 3.

The computing device 1 may contain a hard drive 9 that stores a plurality of software programs (e.g. an operating system, software drivers, etc.). The hard drive 9 may also contain an updated version of the firmware (i.e., the latest version of the firmware issued by the manufacturer). A software driver acts as a translator or intermediary between the card 3 and software programs that use the card 3. The card 3 has its own set of specialized commands that are only known by its software driver. The software programs (other than the software driver) may access the card 3 by using generic commands. The software driver accepts these generic commands and then translates them into specialized commands for the card 3 to perform. The software driver may also perform the method, according to the present invention, of automatically updating the firmware to the latest version.

As mentioned above, the computing device 1 may be connected to the network 13 which may be a wired network utilizing, for example, ethernet. Alternatively or in addition, the network 13 may be connected to the computing device 1 wirelessly using the card 3. The computing device 1 may use the network 13 to receive the updated versions of the firmware.

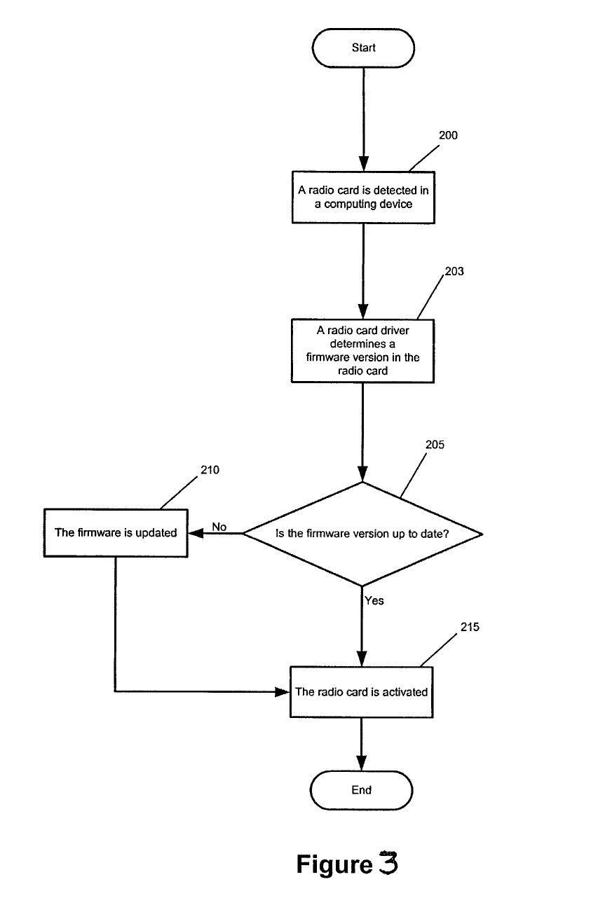

FIG. 3 shows a method according to the exemplary embodiment of the present invention. The method is described with reference to FIGS. 1 and 2. Those skilled in the art will understand that other systems having varying configurations may be used to implement the exemplary method.

In step 200, during an initialization process of the computing device 1, the computing device 1 detects a presence of the card 3. The detection of the card 3 initiates the method, and may occur, for example, in the following instances. The first instance is when the computing device 1 is powered on. Generally, when the computing device 1 is powered on, it determines devices that are attached to it, e.g., a keyboard, a mouse, a hard drive, a radio card, etc. The computing device 1 runs a corresponding software driver for each of the detected devices.

The second instance in which the method may be initiated is when the card 3 is attached to the computing device 1 after the computing device 1 is powered on. In this instance, the computing device 1 may support, for example, a plug-and-play technology and automatically detect the card 3. In both instances, upon detection of the card 3, the computing device 1 initiates the software driver to configure the card 3. Alternatively, a user may initiate the software driver after attaching the card 3, in order for the computing device 1 to detect it.

In step 203, the software driver determines a current firmware version of the card 3. The current firmware version number may be stored at a particular address in the nonvolatile memory 11. The software driver may either address the nonvolatile memory 11 directly to obtain the current version number or may need to initiate the firmware to do so.

If the software driver needs to initiate the firmware to determine the version, then the software driver subsequently sends a query for the current version number. The firmware then responds with the current firmware version stored at the particular address of the nonvolatile memory 11. The software driver stores the current firmware version on the hard drive or some other memory bank attached to the computing device 1.

In step 205, the software driver determines whether the current firmware is up to date (i.e., the latest firmware available form the manufacturer). This may be determined by comparing the current version number obtained in Step 203 with the latest version number of the firmware produced by the manufacturer. This latest version of the firmware may be stored, for example, on the server 15, a particular Internet Protocol (“IP”) address or some other device connected to the network 13. If the computing device 1 is connected to the network 13, then the software driver may check the latest version of the firmware by utilizing a file transfer protocol (“FTP”) or a web site that contains the information.

Alternatively, the latest version of the firmware may be on the hard drive 9 in a predetermined location, (i.e., directory or path, with a predetermined file name). The latest version of the firmware may have been placed on the hard drive 9 by the user. Alternatively, when the user logs in to the network 13, a program automatically downloads the latest version of the firmware from the server 15 or other device connected to the network 13.

A firmware version may be denoted by a number which may be an integer or floating-point number and a higher number may indicate a later version. The current version number and the latest version are compared. If the current version number is less than the latest version number, the firmware of the card 3 is out of date and needs to be updated. Those skilled in the art will understand that there are other comparisons which may be used in addition to numbers, for example, text strings, hash tables, dates, etc.

In Step 210, once the firmware of the card 3 was determined to be out of date, the firmware is updated. This may be accomplished by a process called “flashing the memory”. This process entails erasing the contents of the nonvolatile memory 11 and replacing it with entirely new contents. In particular, the software driver writes the updated firmware version, (i.e., formerly the latest version of the firmware), that is stored on the hard drive 9 or on the server 15 into the nonvolatile memory 11. This may also include writing a new version number into the nonvolatile memory 11 at the predetermined address (i.e., updating the current version number).

In Step 215, the card 3 is activated. The software driver initiates the firmware in the nonvolatile memory 11. Then, the software driver completes any other initial configuration procedures that are necessary to use the card 3 to communicate with the network 13. After all initial configurations are done, the software driver accepts commands to the card 3 and performs standard functions of the driver. Now, the computing device 1 is ready to utilize the card 3.

The present invention has been described with reference to an embodiment utilizing the slot 5 for the card 3, the hard drive 9 to store the driver software and perform other functions and a method that is initiated by the detection of the radio card. One skilled in the art would understand that the present invention may also be successfully implemented, for example, using any portable card which has non-volatile memory and may be inserted/attached to any computer slots/connectors (e.g., Peripheral Component Interconnect (“PCI”) slot, mini-PCI, Compact Flash, USB, etc.). The latest software may also be stored on a compact disc or DVD to store the driver software; the method may be initiated on periodical basis in accordance with a predetermined scheduled, etc. Accordingly, various modifications and changes may be made to the embodiments without departing from the broadest spirit and scope of the present invention as set forth in the claims that follow. The specification and drawings are accordingly to be regarded in an illustrative rather than restrictive sense.

What is claimed is:

1. A method for automatically updating a firmware program, comprising the steps of:
(a) determining, during an initialization process of a portable card, a first version of the firmware program, the first version being currently stored in a non-volatile memory of the card, the card being connected to a computing device;
(b) comparing the first version with a second version of the firmware program;
(c) automatically updating the first version with the second version in the non-volatile memory if the second version is a subsequent version of the firmware program; and
(d) after step (c), activating the card using the second version.

2. The method according to claim 1, further comprising the steps of:
powering on the computing device; and
detecting a presence of the card.

3. The method according to claim 1, wherein the card is a plug-and-play card, and the method further comprises the step of:
before step (a), detecting the card after the computing device has completed an initialization procedure.

4. The method according to claim 1, wherein the second version is situated in at least one of (a) the computing device and (b) a further computing device, the further computing device communicating with the computing device via a communication network.

5. The method according claim 4, wherein the further computing device periodically uploads the second version to the computing device.

6. The method according to claim 1, wherein in step (b), the first and second versions are compared as a function of at least one of (a) a corresponding date of creation and (b) a corresponding version number.

7. The method according to claim 1, wherein the portable card includes is a radio card.

8. The method according to claim 7, wherein the radio card is a wireless radio card.

9. The method according to claim 1, wherein step (c) includes the following sub-steps:
erasing the first version from the non-volatile memory of the card, and
copying the second version into the non-volatile memory.

10. A system for automatically updating a firmware program, comprising:
a computing device; and
a portable card including a non-volatile memory, the memory storing a first version of the firmware program, the card being attached to the computing device,
wherein during an initialization process of the card, the first version is determined and compared with a second version of the firmware program,
wherein the first version is automatically updated with the second version in the non-volatile memory if the second version is a subsequent version of the firmware program, and
wherein the card is activated using the second version.

11. The system according to claim 10, wherein the computing device includes a slot which is adapted to accept the card.

12. The system according to claim 10, wherein a presence of the card is detected when the computing device is powered on.

13. The system according to claim 10, wherein the card is a plug-and-play card and is attached to the computing device after the computing device has completed an initiation procedure.

14. The system according to claim 10, wherein the second version is stored on at least one of (a) the computing device and (b) a further computing device, the further computing device communicating with the computing device via a communication network.

15. The system according claim 14, wherein the further computing device periodically uploads the second version to the computing device.

16. The system according to claim 10, wherein the first and second versions are compared as a function of at least one of (a) a corresponding date of creation and (b) a corresponding version number.

17. The system according to claim 10, wherein the portable card includes is a radio card.

18. The system according to claim 17, wherein the radio card includes is a wireless radio card.

19. The system according to claim 10, wherein the firmware is updated by (i) erasing the first version from the non-volatile memory of the card, and then (ii) copying the second version into the non-volatile memory.
